(19) United States
(12) Patent Application Publication
(10) Pub. No.: US 2026/0330339 A1
(43) Pub. Date: Oct. 22, 2026

(54) SYSTEMS AND METHODS FOR RESERVING GOLF TEE TIMES

(71) Applicant: Tee Tours LLC, Perrysville, IN (US)

(72) Inventor: Brendan Noggle, Perrysville, IN (US)

(73) Assignee: Tee Tours LLC, Perrysville, IN (US)

(21) Appl. No.: 19/468,509

(22) Filed: Feb. 3, 2026

Related U.S. Application Data
(60) Provisional application No. 63/753,621, filed on Feb. 4, 2025.

(51) Int. Cl. G06Q 10/02

(52) U.S. Cl. CPC G06Q 10/026; G06Q 10/025

(57) ABSTRACT

A computer-implemented system and method are disclosed for coordinating golf-related reservations. The system includes at least one processor and a non-transitory computer-readable storage medium storing instructions that cause the system to maintain a database of golf courses having associated tee time availability and course attribute data. The system receives search requests from user devices, generates available tee times based on the search requests, and enables reservation of selected tee times that are associated with user accounts. In some embodiments, the system further enables reservation of lodging accommodations, registration for golf scrambles, organization of group golf outings, and processing of payments. Course attributes may include landscape features used to filter search results. The system may operate as a cloud-based platform accessible via web browsers and mobile applications.

### PRIORITY

The present application is related to, and claims the priority benefit of, U.S. provisional patent application serial no. 63/752,621, filed Feb. 4, 2025, the contents of which are incorporated herein directly and by reference in their entirety.

### BACKGROUND

Golfers often face challenges when attempting to coordinate their tee times, lodging accommodations, and related activities for golf outings. Current solutions either focus solely on booking tee times, while lodging and golf outings are handled separately, or are overly fragmented, requiring golfers to use multiple platforms to complete their bookings. There is a need for an integrated platform that provides golfers with an all-encompassing solution for scheduling tee times, booking accommodations, and participating in golf scrambles or corporate outings, while enabling golf courses and hotels to register and manage their offerings through a single system.

In addition, existing golf course management and tee time platforms frequently rely on third-party barter models, prepaid inventory purchasing, or long-term contractual obligations that can reduce a golf course’s pricing autonomy, limit operational flexibility, and negatively impact margins, particularly for seasonal or publicly accessible golf courses. There exists a need for a transparent, course-controlled reservation system that allows golf courses to maintain ownership of their inventory, pricing, and customer relationships while still enabling centralized discovery and booking by golfers.

### BRIEF SUMMARY

The present disclosure includes disclosure of a website and system that enables golfers to schedule tee times at public golf courses, reserve hotel and resort rooms in connection with their tee times, and allows golf courses, hotels, and resorts to register and manage their availability on the platform. In one embodiment, the system operates as a golf course management software platform provided directly to golf courses for managing tee sheets, bookings, golfer records, pricing rules, staff access, and operational workflows, while simultaneously enabling optional exposure of live tee time inventory to a centralized golfer-facing tee time discovery marketplace operated by the same platform. Golf courses can specify unique features such as mountain views, lakes, or oceanfront landscapes, helping golfers choose based on preferences. Additionally, the system will include a golf scramble feature, enabling golf courses to list available scrambles, and a corporate outing feature for event planners to organize and book full golf outings. This integrated solution aims to streamline the process for both golfers and service providers (golf courses and hotels/resorts) through a user-friendly online platform. In certain embodiments, golf courses must utilize the platform’s native tee sheet and booking software in order to publish live inventory to the centralized tee time marketplace, thereby ensuring inventory accuracy, real-time synchronization, and avoidance of double booking.

The present disclosure includes disclosure of a system for scheduling and coordinating tee times and/or hotel reservations and/or golf-related events, comprising a website platform and/or smart device application platform operating software and configured to enable golfers to search for and book tee times at golf courses, enable golfers to reserve accommodations at hotels or resorts in connection with their booked tee times, enable golf courses to list their tee times and course features on the system, and optionally enable hotels and resorts to list available rooms in connection with golfers’ tee times. The system may be configured such that publication of tee times to a golfer-facing marketplace is optional and controlled by each golf course, with the golf course retaining full control over which tee times are made publicly available, pricing applied to such tee times, and booking rules governing access.

In one embodiment, the system only retains a commission when a reservation is generated through the platform’s golfer-facing marketplace, and no commission is retained for reservations booked directly through a golf course’s own website or point-of-sale interface using the platform software.

The present disclosure includes disclosure of a system for scheduling and coordinating tee times and/or hotel reservations and/or golf-related events, wherein the website platform is further configured to enable golfers to register for and book participation in golf scrambles hosted by golf courses.

The present disclosure includes disclosure of a system for scheduling and coordinating tee times and/or hotel reservations and/or golf-related events, wherein the website platform is further configured to enable golfers and/or event planners to organize and book group golf events, including tee times, accommodations, and event services.

The present disclosure includes disclosure of a system for scheduling and coordinating tee times and/or hotel reservations and/or golf-related events, comprising software stored upon a storage medium and having instructions executable by a processor in communication with the storage medium to operate the software configured to enable the tasks referenced therein.

The present disclosure includes disclosure of a computer-implemented system for coordinating golf-related reservations, comprising at least one processor, and a non-transitory computer-readable storage medium storing instructions that, when executed by the at least one processor, cause the system to maintain a database of golf courses including tee time availability data and course attribute data, receive a search request from a user device, generate a list of available tee times based on the search request, enable selection and reservation of a tee time, and associate the reserved tee time with a user account.

The present disclosure includes disclosure of a computer-implemented system for coordinating golf-related reservations, wherein the instructions further cause the system to enable reservation of an accommodation at a hotel or resort in association with the reserved tee time.

The present disclosure includes disclosure of a computer-implemented system for coordinating golf-related reservations, wherein the course attribute data includes landscape attributes selected from mountains, lakes, rivers, oceanfront, forests, desert, and dunes.

The present disclosure includes disclosure of a computer-implemented system for coordinating golf-related reservations, wherein the instructions further cause the system to enable golf courses to register and manage tee time availability through an administrative interface.

The present disclosure includes disclosure of a computer-implemented system for coordinating golf-related reservations, wherein the instructions further cause the system to enable golf courses to list golf scramble events.

The present disclosure includes disclosure of a computer-implemented system for coordinating golf-related reservations, wherein users may register and submit payment for participation in a golf scramble.

The present disclosure includes disclosure of a computer-implemented system for coordinating golf-related reservations, wherein the instructions further cause the system to enable organization of a group golf outing including multiple tee times.

The present disclosure includes disclosure of a computer-implemented system for coordinating golf-related reservations, wherein the group golf outing includes coordinated lodging reservations.

The present disclosure includes disclosure of a computer-implemented system for coordinating golf-related reservations, wherein the instructions further cause the system to enable creation of a multi-course golf itinerary.

The present disclosure includes disclosure of a computer-implemented system for coordinating golf-related reservations, wherein the system processes payment for at least one of a tee time, accommodation, or golf event.

The present disclosure includes disclosure of a computer-implemented system for coordinating golf-related reservations, wherein the system retains a commission associated with the payment.

The present disclosure includes disclosure of a computer-implemented system for coordinating golf-related reservations, wherein the user device comprises a smart device executing a mobile application.

The present disclosure includes disclosure of a computer-implemented system for coordinating golf-related reservations, wherein tee time availability published to a consumer-facing marketplace is derived exclusively from a tee sheet managed within the system by the golf course.

The present disclosure includes disclosure of a computer-implemented system for coordinating golf-related reservations, wherein the golf course selectively controls which tee times are made publicly available for booking.

The present disclosure includes disclosure of a computer-implemented system for coordinating golf-related reservations, wherein a commission is retained only for reservations generated through the marketplace portion of the platform.

The present disclosure includes disclosure of a computer-implemented system for coordinating golf-related reservations, wherein the system further provides point-of-sale functionality for food, beverage, or retail purchases associated with a golf course.

The present disclosure includes disclosure of a computer-implemented method for coordinating golf reservations, comprising receiving tee time availability data from a plurality of golf courses, receiving a search request from a user device, generating a list of available tee times, receiving a selection of a tee time, and associating the selected tee time with a user account.

The present disclosure includes disclosure of a computer-implemented method for coordinating golf reservations, further comprising reserving an accommodation associated with the selected tee time.

The present disclosure includes disclosure of a computer-implemented method for coordinating golf reservations, further comprising filtering tee times based on landscape attributes.

The present disclosure includes disclosure of a computer-implemented method for coordinating golf reservations, further comprising registering a golf course and storing course profile data.

The present disclosure includes disclosure of a computer-implemented method for coordinating golf reservations, further comprising listing golf scramble events and enabling user registration.

The present disclosure includes disclosure of a computer-implemented method for coordinating golf reservations, further comprising organizing a group golf outing.

The present disclosure includes disclosure of a computer-implemented method for coordinating golf reservations, further comprising processing payment for a reservation.

The present disclosure includes disclosure of a computer-implemented method for coordinating golf reservations, further comprising retaining a commission from the payment.

The present disclosure includes disclosure of a reservation coordination platform, comprising one or more servers in communication with user devices over a network, a reservation database storing tee time records associated with a plurality of golf courses; and reservation management logic executed by the one or more servers and configured to receive availability data from the plurality of golf courses, synchronize the availability data with the reservation database, present selectable tee times to user devices based on the synchronized availability data, and generate a reservation record linking a selected tee time to a user profile.

The present disclosure includes disclosure of a reservation coordination platform, wherein the availability data includes pricing data set by the golf courses.

The present disclosure includes disclosure of a reservation coordination platform, wherein the reservation management logic enforces booking rules defined by individual golf courses.

The present disclosure includes disclosure of a reservation coordination platform, wherein the reservation database further stores landscape attribute data associated with the golf courses.

The present disclosure includes disclosure of a reservation coordination platform, wherein the selectable tee times are filtered based on at least one selected landscape attribute.

The present disclosure includes disclosure of a non-transitory computer-readable storage medium storing instructions that, when executed by one or more processors, cause a computing system to receive tee time availability data from golf course systems, store the tee time availability data in a centralized database, receive a tee time search request from a user device, identify available tee times satisfying the search request, and reserve a selected tee time in response to user confirmation.

The present disclosure includes disclosure of a non-transitory computer-readable storage medium, wherein the instructions further cause the computing system to associate a lodging reservation with the selected tee time.

The present disclosure includes disclosure of a non-transitory computer-readable storage medium, wherein the instructions further cause the computing system to enable payment processing for the reservation.

The present disclosure includes disclosure of a non-transitory computer-readable storage medium, wherein a commission is retained by an operator of the computing system.

The present disclosure includes disclosure of a computer-implemented system for coordinating golf events, comprising at least one processor, and instructions executable by the at least one processor to enable listing of golf scramble events associated with golf courses, registration of participants for the golf scramble events; and processing of payments for participation in the golf scramble events.

The present disclosure includes disclosure of a computer-implemented system for coordinating golf events, The system of claim 30, wherein the golf scramble events are searchable by date and location.

The present disclosure includes disclosure of a computer-implemented system for coordinating golf events, wherein the golf scramble events are searchable based on course attributes.

The present disclosure includes disclosure of a computer-implemented method for organizing a group golf outing, comprising receiving a request to organize a group golf event, reserving multiple tee times at one or more golf courses, associating the reserved tee times with a single group identifier, and generating a consolidated booking record for the group golf outing.

The present disclosure includes disclosure of a computer-implemented method for organizing a group golf outing, further comprising reserving lodging accommodations associated with the group golf outing.

The present disclosure includes disclosure of a computer-implemented method for organizing a group golf outing, further comprising coordinating food, beverage, or event services.

The present disclosure includes disclosure of a computer-implemented system for coordinating golf-related reservations, wherein the database of golf courses is updated in real time based on input from golf course administrators.

The present disclosure includes disclosure of a computer-implemented system for coordinating golf-related reservations, wherein cancellations and modifications to tee time reservations are synchronized across user accounts and golf course systems.

The present disclosure includes disclosure of a computer-implemented system for coordinating golf-related reservations, wherein the system generates notifications to user devices in response to reservation changes.

The present disclosure includes disclosure of a computer-implemented system for coordinating golf-related reservations, wherein access to administrative functionality is restricted based on user roles.

The present disclosure includes disclosure of a computer-implemented system for coordinating golf-related reservations, wherein the platform operates as a cloud-based service accessible via both web browsers and mobile applications.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a block diagram of a computer, components thereof, and software used in connection therewith, according to an exemplary embodiment of the present disclosure.

FIG. 2 shows an exemplary information page, according to an exemplary embodiment of the present disclosure.

FIG. 3 shows an exemplary information page, according to an exemplary embodiment of the present disclosure.

FIG. 4 shows an exemplary user sign up page, according to an exemplary embodiment of the present disclosure.

FIG. 5 shows an exemplary tee time search page, according to an exemplary embodiment of the present disclosure.

FIG. 6 shows example filters that can be selected from the tee time search page, according to an exemplary embodiment of the present disclosure.

FIG. 7 shows an exemplary golf course onboarding page, according to an exemplary embodiment of the present disclosure.

FIG. 8 shows an exemplary golf course onboarding page, according to an exemplary embodiment of the present disclosure.

FIG. 9 shows an exemplary golf course onboarding page, according to an exemplary embodiment of the present disclosure.

FIG. 10 shows an exemplary golf course onboarding page, according to an exemplary embodiment of the present disclosure.

FIG. 11 shows an exemplary golf course description page, according to an exemplary embodiment of the present disclosure.

FIG. 12 shows an exemplary calendar page, according to an exemplary embodiment of the present disclosure.

FIG. 13 shows an exemplary calendar page, according to an exemplary embodiment of the present disclosure.

FIG. 14 shows an exemplary golf course calendar page, according to an exemplary embodiment of the present disclosure.

FIG. 15 shows an exemplary payment onboarding page, according to an exemplary embodiment of the present disclosure.

FIG. 16 shows an exemplary payment onboarding page, according to an exemplary embodiment of the present disclosure.

FIG. 17 shows an exemplary dashboard page, according to an exemplary embodiment of the present disclosure.

FIG. 18 shows an exemplary tee sheet creation page, according to an exemplary embodiment of the present disclosure.

FIG. 19 shows an exemplary golfers list page, according to an exemplary embodiment of the present disclosure.

FIG. 20 shows an exemplary servicing pricing page, according to an exemplary embodiment of the present disclosure FIG. 21 shows an exemplary golf course management page, according to an exemplary embodiment of the present disclosure.

FIG. 22 shows an exemplary price template page, according to an exemplary embodiment of the present disclosure.

FIG. 23 shows an exemplary staff page, according to an exemplary embodiment of the present disclosure.

FIG. 24 shows an exemplary start screen for a smart device application, according to an exemplary embodiment of the present disclosure.

FIG. 25 shows an exemplary golf course search screen for a smart device application, according to an exemplary embodiment of the present disclosure.

FIG. 26 shows an exemplary tee time selection screen for a smart device application, according to an exemplary embodiment of the present disclosure.

FIG. 27 shows an exemplary booking screen for a smart device application, according to an exemplary embodiment of the present disclosure.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present disclosure includes disclosure of systems and methods, using software, a) provided to golf courses so that golf course managers can use to track golf tee times and bookings, and/or b) to provide a form of marketing to golf courses via an online database and email, text, or otherwise notify golfers via a smart device application said marketing information, and/or c) to provide a website and/or a smart device application through which golfers can reserve tee times at golf courses, and/or d) to provide information to golfers concerning the reservation of tee times and rates/fees at golf courses via email, text, or otherwise via s smart device application, and/or e) to provide information to golfers on golf courses via a website database.

In at least one embodiment of a system of the present disclosure, and pertaining to business to business (B2B) sales, the system offers cloud-based tee time management software to golf courses around the world. Said software is available to any public golf course that wants to use the services offered by the platform. Golf courses around the world can be offered a risk-free opportunity allowing them to be included within the system database so that golfers can readily search for and find said golf courses. In at least one embodiment, the system functions primarily as a business-to-business (B2B) golf course management platform, providing golf courses with a unified system for tee sheet management, online booking, point-of-sale transactions, golfer databases, staff permissions, reporting, and payment processing. The golfer-facing tee time discovery and booking marketplace operates as an optional extension of the B2B platform, rather than as a standalone consumer booking system.

Systems of the present disclosure can use 100% cloud-based software, meaning that there will be no downloads required in order to use said software. Should a user wish to use a smart device application, exemplary systems of the present disclosure can include the use of said application All uses of the software can take place online if desired.

Various exemplary systems of the present disclosure can also use a landscape attribute feature on the software build. Said feature provides golfers the ability to find golf courses based on their preferences when it comes to finding golf courses based on the landscape attributes selected by the golf course. For example, golf courses can be given the ability to select whether their golf course has one or more of the following characteristics - mountains, rivers, lakes, ocean-front, forests, desert, dunes, and the like.

In at least one exemplary system of the present disclosure, said system can also include a golf scramble feature, allowing golf courses to list their golf scrambles on their system profile and calendar. Golfers would then be able to search for golf scrambles on the system website, allowing them to book and pay for their spot in the golf scramble. Furthermore, systems of the present disclosure can include a corporate outing feature, having the ability for event planners to use this feature to build a full golf outing all online.

As such, the present disclosure includes disclosure of a system comprising a website platform and/or a smart device application platform that provides golfers with the ability to manage and coordinate tee times, accommodations, golf scrambles, and corporate outings. Golfers can use the website and/or application to search for and book tee times at public golf courses, reserve hotel or resort rooms in connection with their booked tee times, search for and register for golf scrambles hosted by golf courses, and/or book and organize corporate golf outings.

In at least one embodiment of a system of the present disclosure, and pertaining to business to consumer (B2C) use, the system will compile a database including onboarded golf courses from the system user interface that golfers can use to search and book tee times on the website and/or smart device application.

Exemplary systems of the present disclosure can provide software that consumers can use on the system website where they can search, build, and book a fully custom golf trip on their own without having to talk to a travel agent. This software will allow golfers to add multiple golf courses to an itinerary and users can select the days and times they want. Then, in one transaction they can pay for all golf courses they selected for their trip. In some embodiments, the system further includes, or is configured to support in future implementations, a multi-day golf trip builder module that allows users to construct itineraries including multiple golf courses across different dates, with unified booking, scheduling, and payment workflows executed through the platform. Such multi-course itinerary functionality may be enabled for golf courses onboarded onto the platform’s native tee sheet system, thereby ensuring availability integrity across all itinerary components. The system improves computer-implemented reservation technology by eliminating reliance on batch inventory feeds or delayed synchronization mechanisms, instead maintaining a single authoritative tee sheet database that serves both golf course operators and consumer-facing booking interfaces in real time.

Systems of the present disclosure can be limited to only public golf courses as participants. This feature would filter out golf courses system users would not be able to play unless they had a membership. Other filter features can include the landscape attributes referenced herein, as well as a budget filter used to keep the golf trips within a desired budget, such as by filtering out golf courses with course fees higher than a set amount.

As such, the present disclosure includes disclosure of a system comprising a website platform and/or a smart device application platform that provides golf courses with the ability to register their golf course on the platform, offer available tee times for booking, specify the unique features of their golf course (e.g., mountains, lakes, oceanfront, etc.), list available golf scrambles, and/or provide their course’s availability and pricing.

Regarding golf course registration, it is noted that the systems of the present disclosure can facilitate the golf courses creation and management of profiles within the system, where they can specify details about their course, including location, course features (e.g., mountains, rivers, lakes, oceanfront, forests, desert, and dunes, for example), availability for tee times, pricing for tee times, and/or availability of golf scrambles, including dates and booking details.

Golf courses can also create and list golf scrambles on the platform. These scrambles can be tournaments or casual events that golfers can book spots for directly via the website. Golfers can search for available scrambles by location, date, and course features, for example. Golfers can view the listed scrambles, register, and pay for their spots directly through the system.

Regarding corporate outings, the system includes a feature for golfers and/or event planners to book corporate outings. This feature allows users to elect golf courses and reserve tee times for a group, organize and book accommodations at hotels or resorts, and coordinate all logistics of the outing online, including food, beverage, and event-specific needs.

In at least one embodiment of a system of the present disclosure, and pertaining to business to consumer (B2C) use, the system will compile a database including onboarded hotels and/or resorts from the system user interface that golfers can use to search and book hotel and/or resort rooms on the website. As such, the present disclosure includes disclosure of a system comprising a website platform and/or a smart device application platform that provides hotels and/or resorts the ability to use the platform to register their hotel and/or resort rooms, offering accommodation options that align with golfers' tee time bookings.

Hotels and resorts can register their properties on the platform and provide available rooms in connection with golfers’ tee times. Details may include, but are not limited to, room types, pricing, and availability in conjunction with specific tee times.

As for monetization, it is noted that other current third-party golf course booking systems purchase tee times from golf courses at a discounted rate and then resell the tee times to consumers at a higher rate. Conversely, systems of the present disclosure can be monetized using flat commission fee(s), meaning that the golf courses will set the price(s) and the system can benefit from the commissions. Similarly, hotels and/or resorts can set their room prices in the system, with the system earning a commission for each booked and/or paid room reservation.

The platform can integrate a secure payment system for golfers and/or event planners to pay for tee times, accommodations, scrambles, and corporate outings. It also supports payment processing for golf courses and hotels, ensuring a smooth transaction for both parties.

As shown in FIG. 1, exemplary systems and websites of the present disclosure may utilize computer programs, instructions, or software 106 that may be operated via a computer 100, the computer 100 being any number of traditional computer/computational devices, having at least one processor 102 in communication with a non-transitory computer-readable storage medium 104, the storage medium 104 configured to store instructions (i.e., computer programs and/or software) thereon, the processor 102 configured to access said instructions and control the operation of said instructions in connection with the operation of other aspects of the computer 100, peripheral devices, and/or other items in communication with said processor 102. The system may operate as a cloud-based platform accessible via a website and/or a smart device application. In at least one embodiment, no local software 106 installation is required for users accessing the system via a web browser.

The systems and methods described herein are not directed merely to the abstract organization of human activity, but instead provide specific improvements to computer-implemented reservation technology. In particular, the disclosed embodiments improve the manner in which computing systems store, synchronize, and process reservation data across multiple independent entities, including golf courses, lodging providers, and user devices.

In one or more embodiments, the system maintains structured reservation records in a centralized database and dynamically synchronizes tee time availability data received from a plurality of golf courses with user-initiated search requests. This synchronization enables real-time generation of available tee times that reflect current availability, pricing rules, and booking constraints defined by individual golf courses. By maintaining and updating reservation records in response to user selections and course-side inputs, the system reduces data inconsistency, double-booking errors, and stale availability information that are common in conventional reservation systems.

Additionally, the disclosed systems improve computer functionality by enabling coordinated processing of multiple interrelated reservation types, such as tee times, lodging accommodations, golf scrambles, and group outings, within a single computing platform. The system links these reservations through common identifiers and database relationships, allowing computing resources to manage complex reservation workflows that would otherwise require multiple disparate systems operating independently.

The use of course attribute data, including landscape attributes, further enhances the operation of the computing system by enabling efficient filtering and querying of reservation data based on structured attribute values stored in memory. This attribute-based filtering reduces computational overhead and improves response time when generating search results for user devices.

In some embodiments, the system enforces booking rules and access controls defined by golf course administrators, including time-based restrictions, pricing constraints, and role-based permissions. These rules are processed by the system at the time of reservation generation and confirmation, thereby improving the reliability and security of the reservation process through computer-implemented rule enforcement.

The disclosed embodiments therefore provide a technical solution to problems arising specifically in the context of computer-implemented reservation systems, including data synchronization, real-time availability management, and coordinated multi-entity booking. The claimed subject matter improves the functioning of computing systems themselves and is not merely a generic application of a known business practice using conventional computer components.

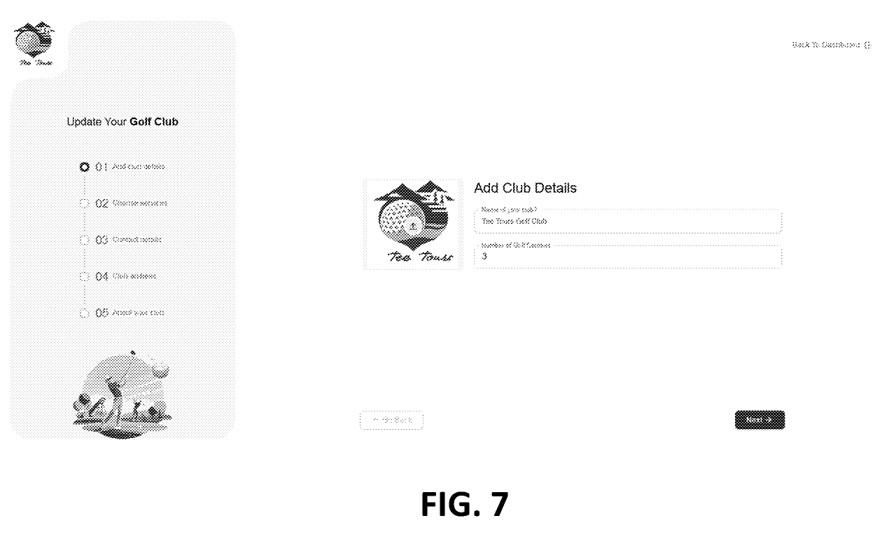

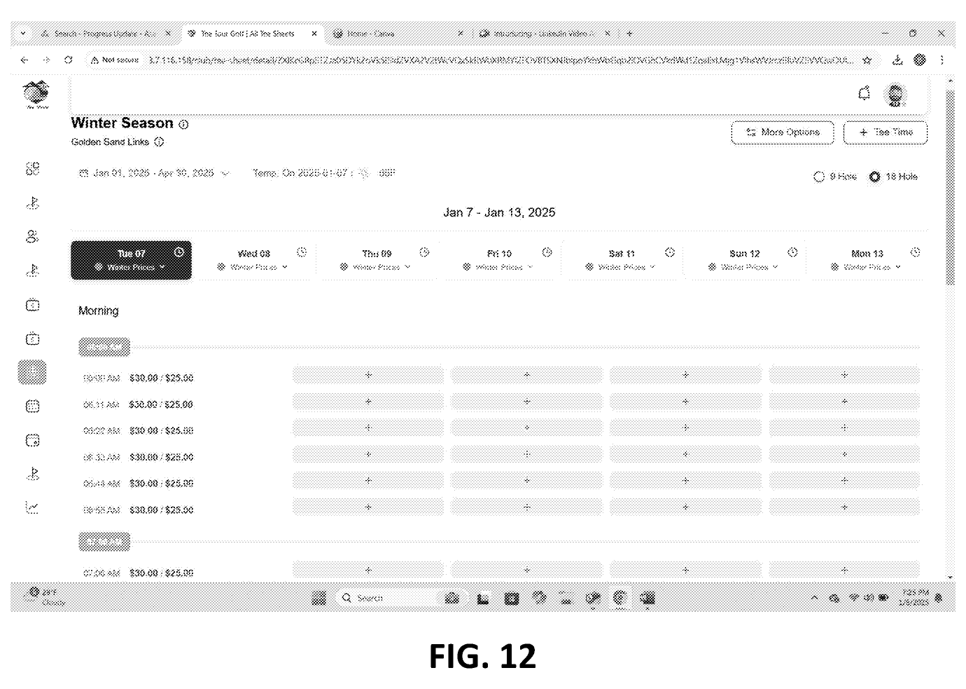

In one or more embodiments, the system maintains a database of golf courses that have been onboarded onto the platform. Golf courses may register through an administrative interface (see, e.g., FIGS. 7–10) to create and manage a course profile. Course profiles may include, but are not limited to:
Course identification and location information
Tee time availability
Pricing information
Course Attributes and amenities
Golf scramble availability
Policies and booking rules
Golf courses may also manage calendars indicating available tee times and scheduled events that affect tee time availability (FIGS. 12–14).

### Tee Time Search and Booking

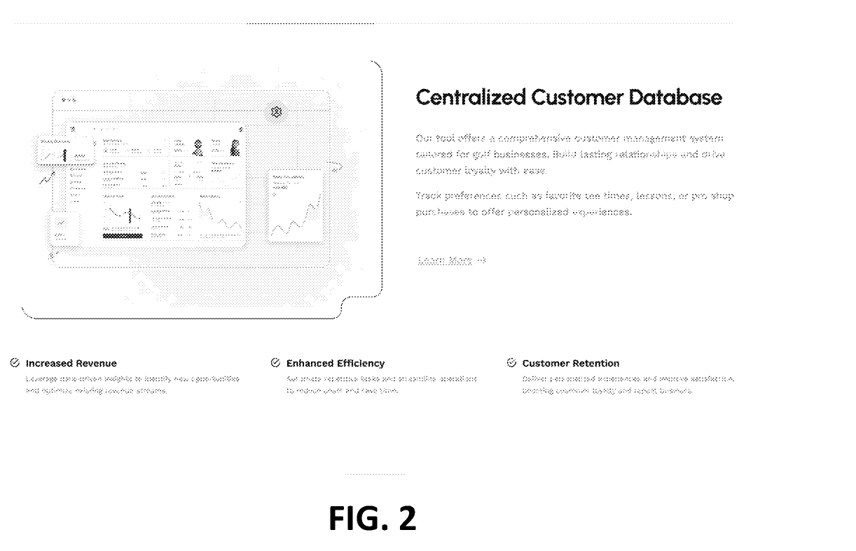

Users (e.g., golfers or event planners) may access the platform via a website or smart device application (FIGS. 2–6, 24–27). The system enables users to search for available tee times based on one or more parameters, including date, location, price, and course attributes.

### Landscape Attributes

In at least one embodiment, the system allows golf courses to identify landscape attributes, such as mountains, lakes, rivers, oceanfront settings, forests, desert terrain, dunes, or other characteristics. These attributes may be stored in association with course profiles and used as filters when generating search results.

Upon selection of a tee time, the system associates the tee time with a user account and creates a reservation record.

### Lodging Integration

In some embodiments, the system further enables users to reserve hotel or resort accommodations in association with a booked tee time. Hotels and resorts may register on the platform and list available rooms, pricing, and availability that can be linked to golf reservations.

The system may present accommodation options during or after tee time selection, allowing users to complete both golf and lodging reservations within a single workflow.

### Golf Scrambles and Corporate Outings

The system may further enable golf courses to list golf scrambles or tournament events. Users may search for available scrambles by location, date, or course attributes, register for participation, and submit payment through the platform.

In addition, the system may include a corporate or group outing feature that allows users or event planners to coordinate multiple tee times, accommodations, and related services for group golf events. These features may be managed through the same platform used for individual tee time bookings.

### Payments and Monetization

The platform may integrate secure payment processing functionality to enable users to pay for tee times, accommodations, scrambles, and group events. In at least one embodiment, golf courses and accommodation providers set their own pricing, while the platform earns revenue through one or more commission fees associated with completed transactions.

### User Interfaces

The figures illustrate exemplary user interfaces for both golfers and golf course administrators, including dashboards, onboarding pages, calendars, booking screens, and administrative management tools. The specific layouts shown are illustrative only, and the disclosed functionality may be implemented using different interface designs.

FIG. 2 shows an exemplary information page of the present disclosure, which can be used for marketing embodiments of the invention. Said page can include information relating to revenue, efficiency, and customer retention, as noted therein.

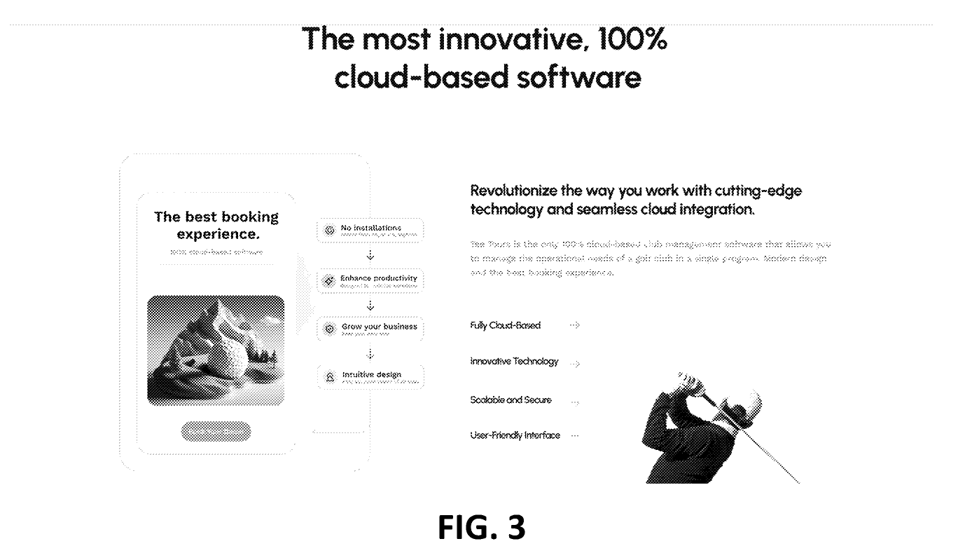

FIG. 3 shows an exemplary information page of the present disclosure, which can be also used for marketing embodiments of the invention. Said page can include information relating to additional benefits of the system and how it can be used by users.

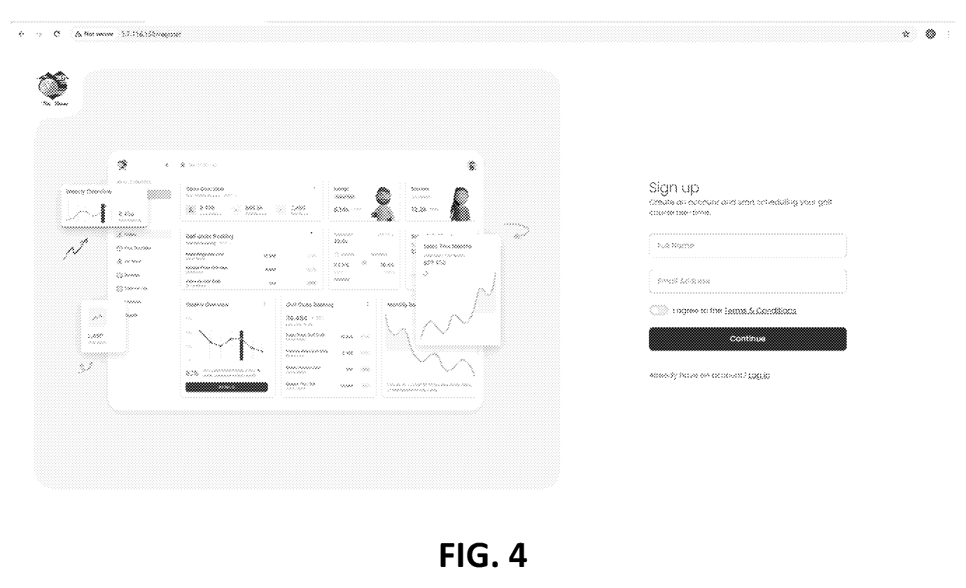

FIG. 4 shows an exemplary user (golfer, event planner, etc.) sign up page, whereby the user can input a name and email address to start the sign up process.

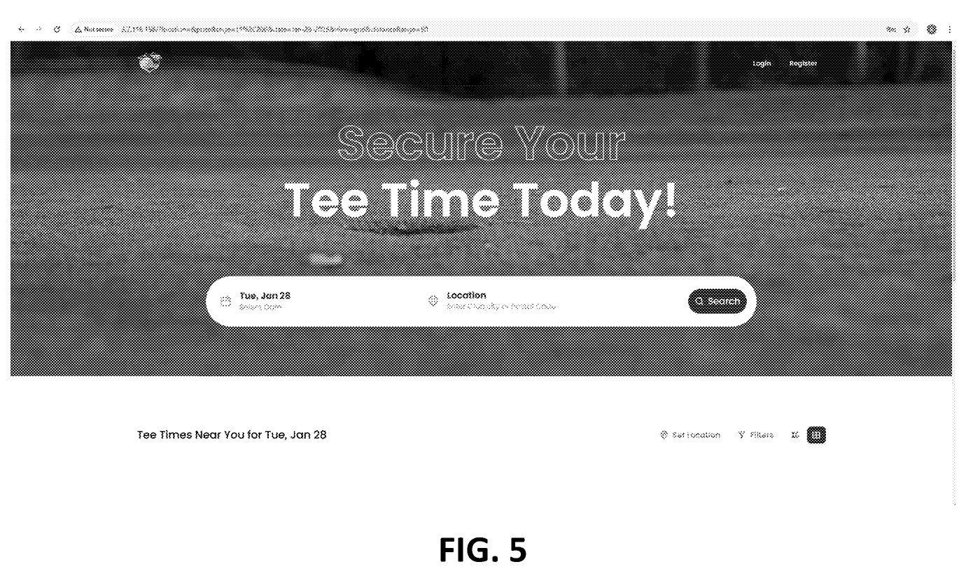

FIG. 5 shows an exemplary tee time search page, whereby a user can select a tee time date and a golf course location by name, city, or postal code.

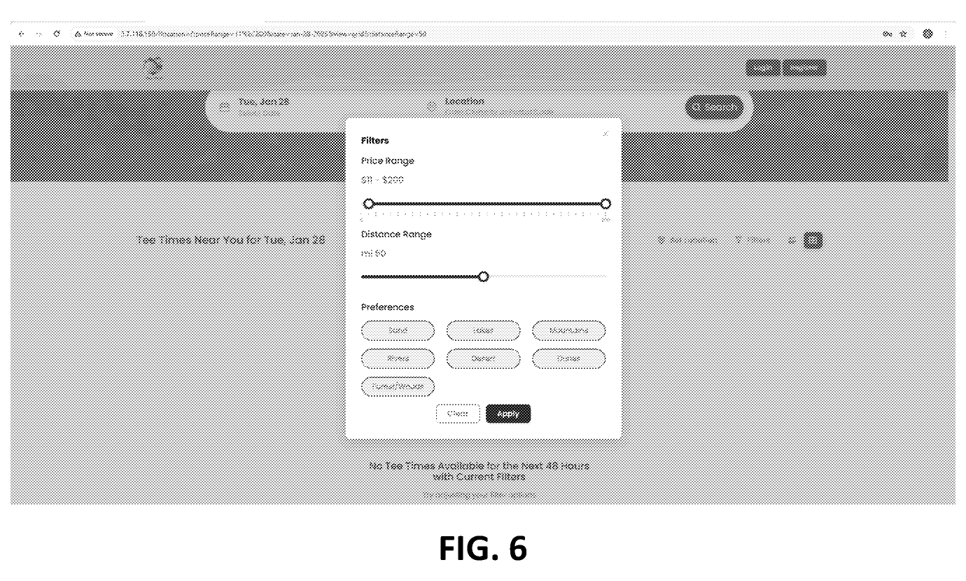

FIG. 6 shows example filters that can be selected from the tee time search page, whereby a user can input filters relating to price, distance, and/or features of the golf course and/or its surroundings, such as sand, lakes, mountains, rivers, desert, dunes, and/or forest/woods.

FIG. 7 shows an exemplary golf course onboarding page of the present disclosure, whereby the golf course representative (or other user or administrator) can input narrative information regarding the course and/or ultimately the golf club services offered, contact information, address, and additional information about the golf club. Onboarding is necessary to have the onboarded golf club be able to offer tee times through the system as disclosed herein. Said page can allow the representative, user, or administrator enter the name of the golf course or club and identify the number of courses related thereto.

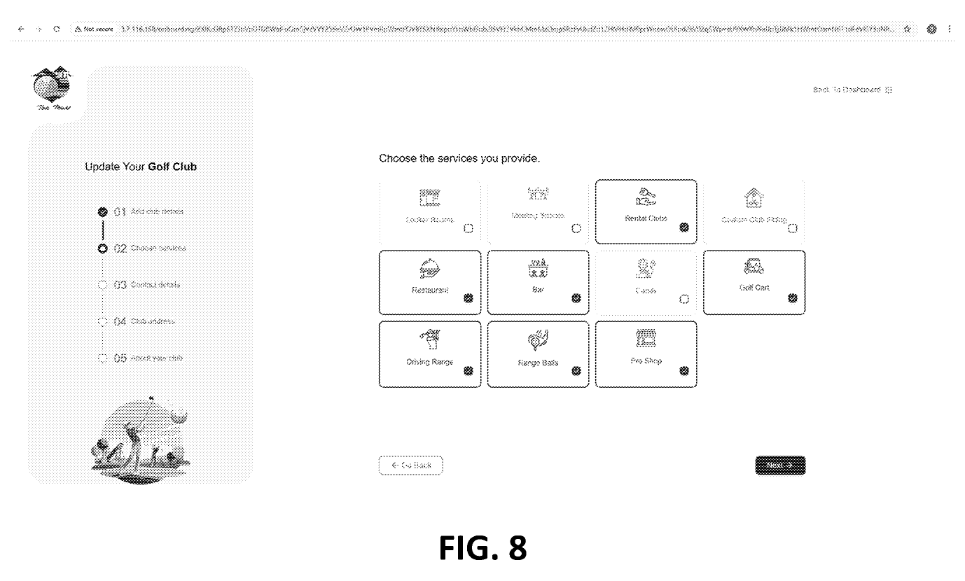

FIG. 8 shows an exemplary golf course onboarding page of the present disclosure, whereby the golf course representative (or other user or administrator) can select features of the golf course being onboarded, such as locker rooms, meeting spaces, rental clubs, custom club fitting, restaurant, bar, caddy service, golf carts, driving range, range balls, and/or pro shop, for example.

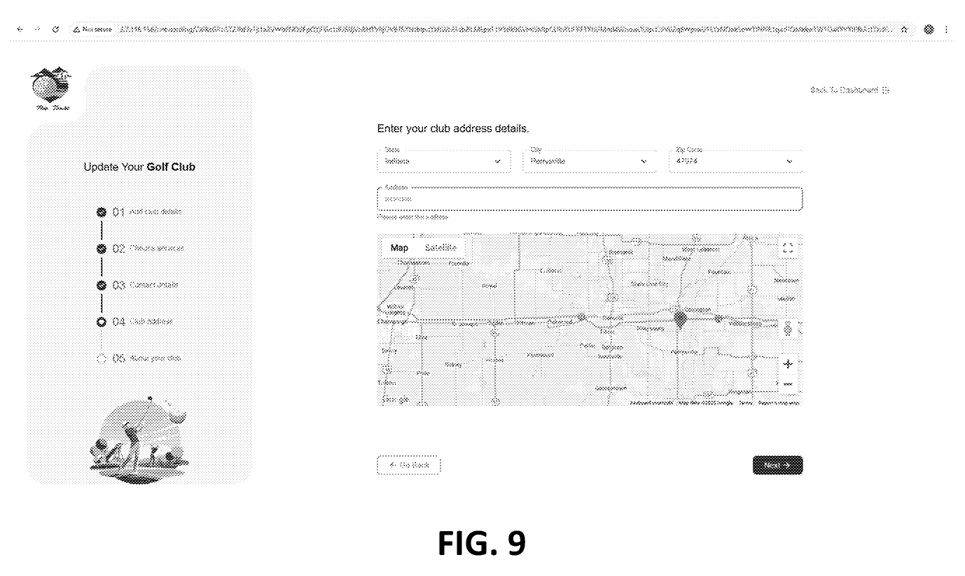

FIG. 9 shows an exemplary golf course onboarding page of the present disclosure, whereby the golf course representative (or other user or administrator) inserts address information for the golf course. An optional map can be available to visually depict the location of the inputted address.

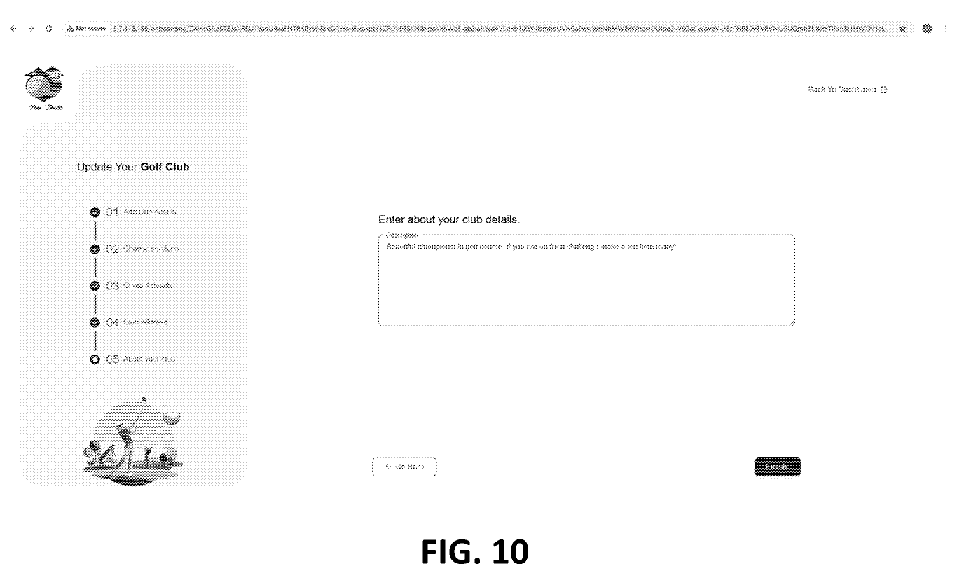

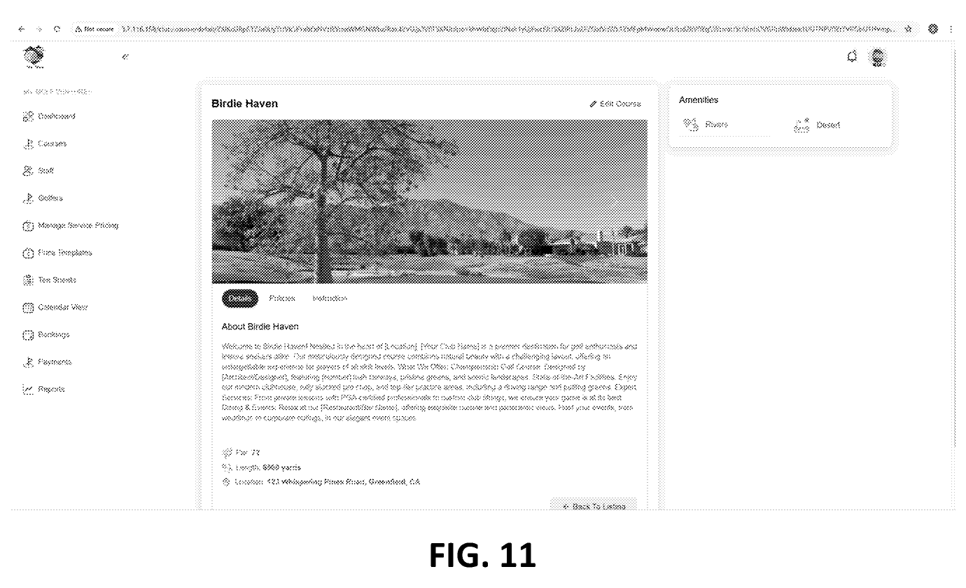

FIG. 10 shows an exemplary golf course onboarding page of the present disclosure, whereby a golf course representative (or other user or administrator) can input narrative information regarding the course and/or ultimately the golf club services offered.

FIG. 11 shows an exemplary golf course description page, whereby information regarding the course, such as photograph(s), narratives, par, course length, address, policies, and/or instruction can be provided to a user. This information is available to a user after the golf course has been onboarded.

FIG. 12 shows an exemplary calendar page for a selected golf course, whereby a user can select tee times by date and time. Said page can also provide additional information, such as a date range, temperature, nine or eighteen hole options, and the like.

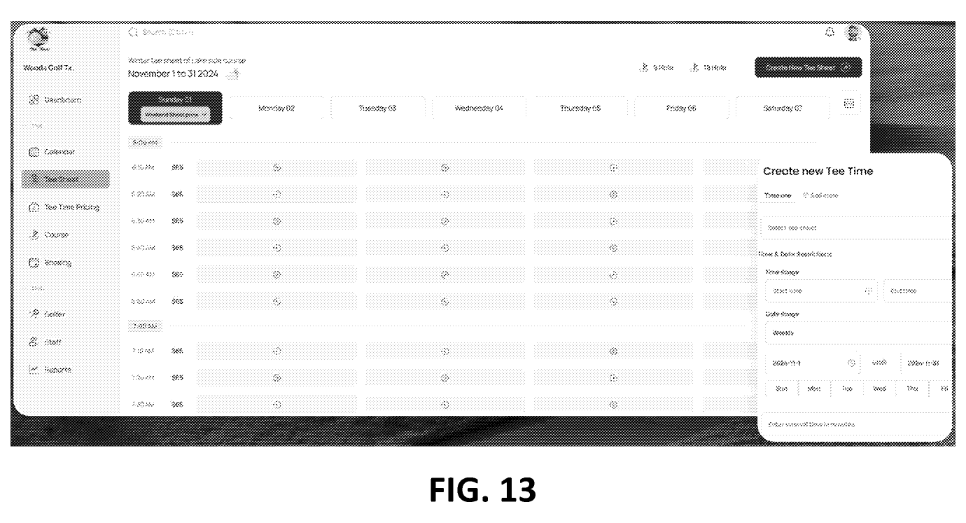

FIG. 13 shows an exemplary calendar page whereby a user has selected the “create new tee sheet” option to select one or more tee times for the selected golf course.

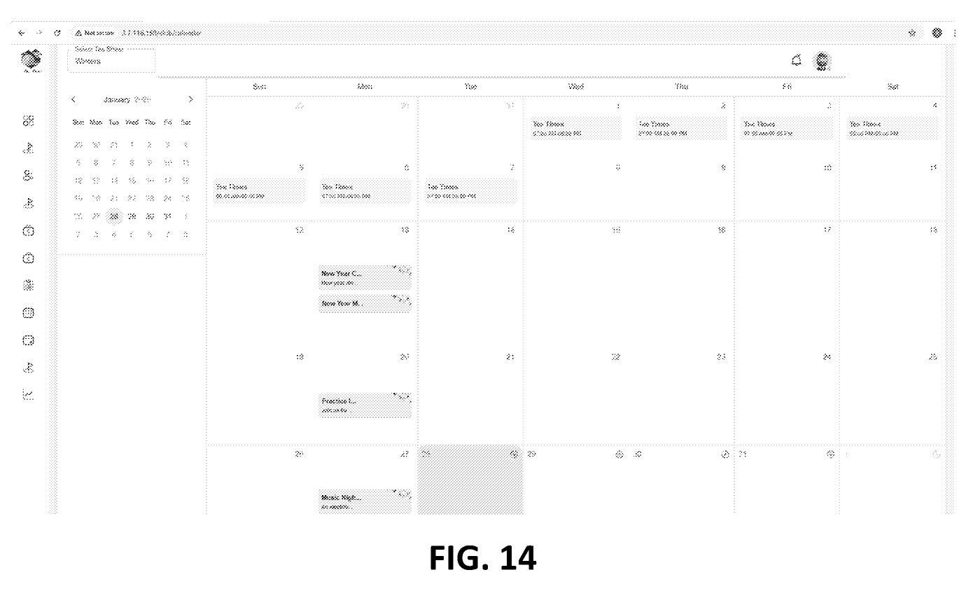

FIG. 14 shows an exemplary golf course calendar page whereby the golf course can identify available tee times and/or other scheduled events that may impact the availability of tee times.

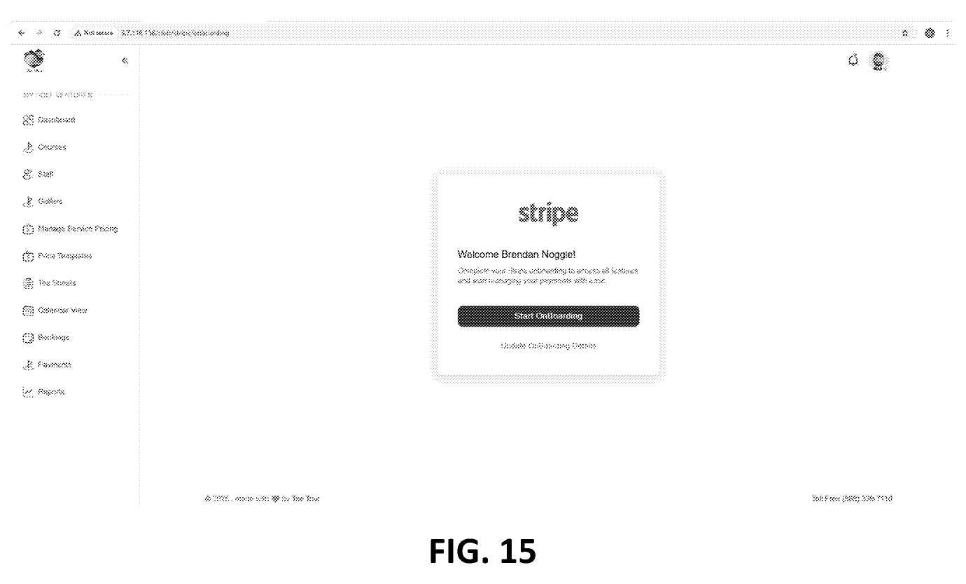

FIG. 15 shows an exemplary payment onboarding page, whereby a user can associate one or more payment mechanisms with exemplary systems of the present disclosure.

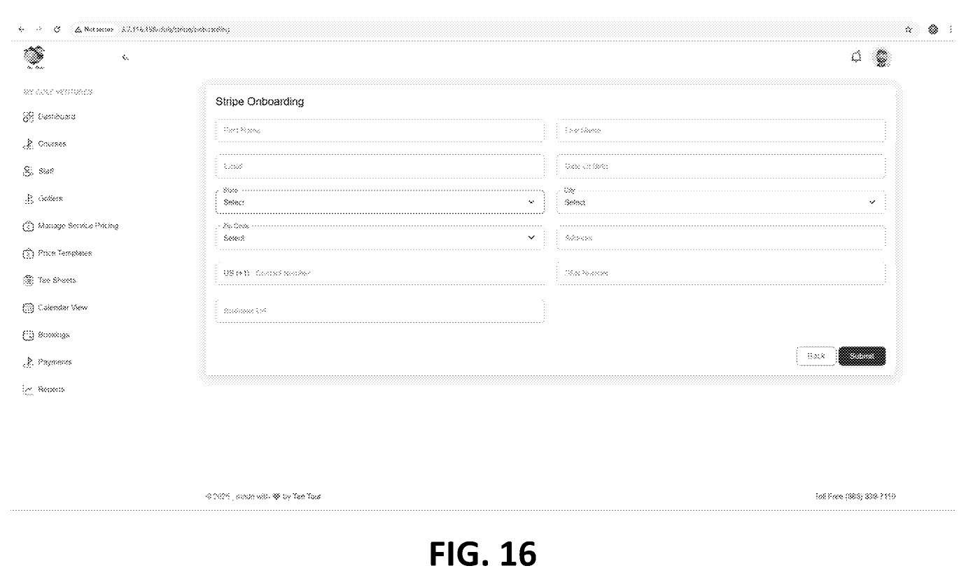

FIG. 16 shows an exemplary payment onboarding page, whereby a user can provide specific user identification information in connection with the ultimate payment mechanism(s) being onboarded.

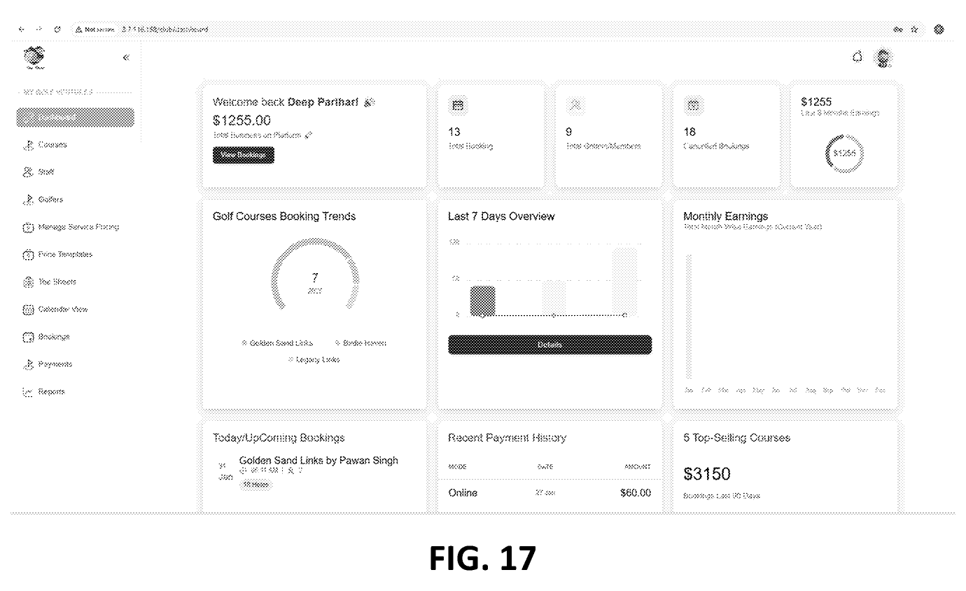

FIG. 17 shows an exemplary dashboard page of the present disclosure, whereby a golf course representative (or other user or administrator) can see information relating to bookings and/or dollar amounts made for booked tee times, the number of active and/or cancelled bookings, the number of golfers or members associated with the onboarded golf club, booking trends (which courses were chosen over others), payment histories, top selling courses, and the like.

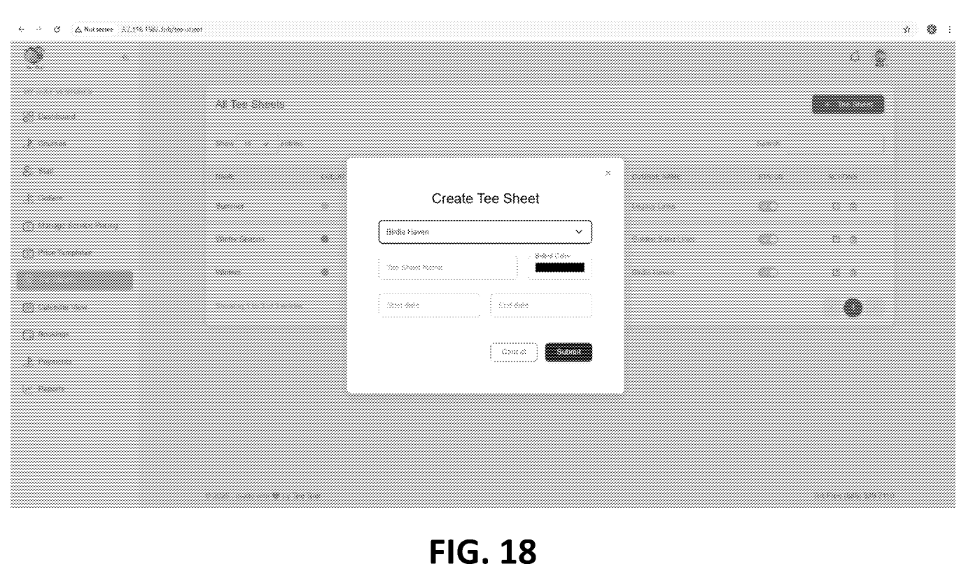

FIG. 18 shows an exemplary tee sheet creation page of the present disclosure, whereby a user can add a golf course to his or her tee sheet managed by the system.

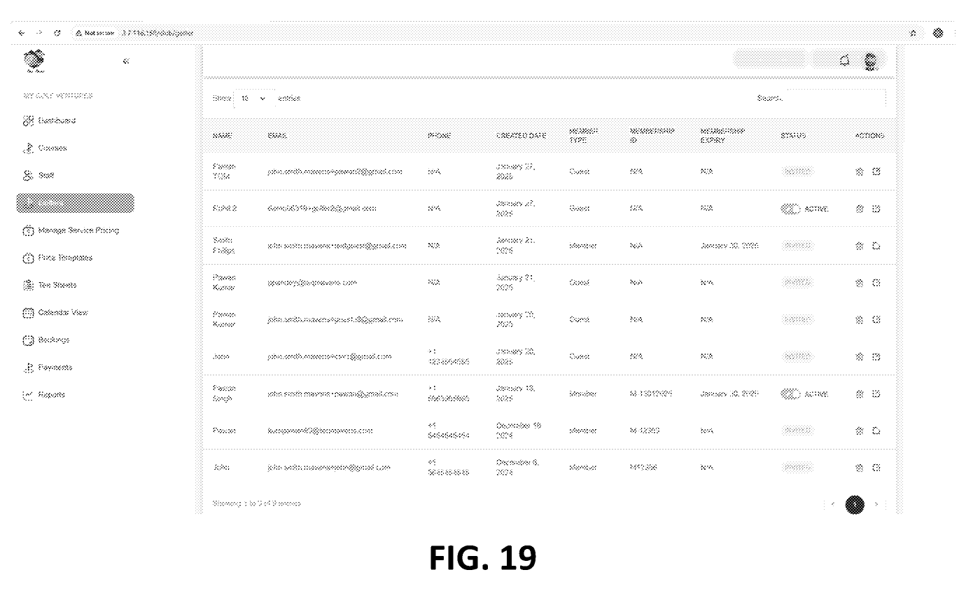

FIG. 19 shows an exemplary golfers list page, whereby information relating to golfers associated with the golf course can be shown, including but not limited to the golfer’s names, email addresses, phone numbers, date added, golfer type (member or guest), membership ID number, membership expiration date, status (invited by the golf course, for example, or actively a participant in connection with the golf course), and the like.

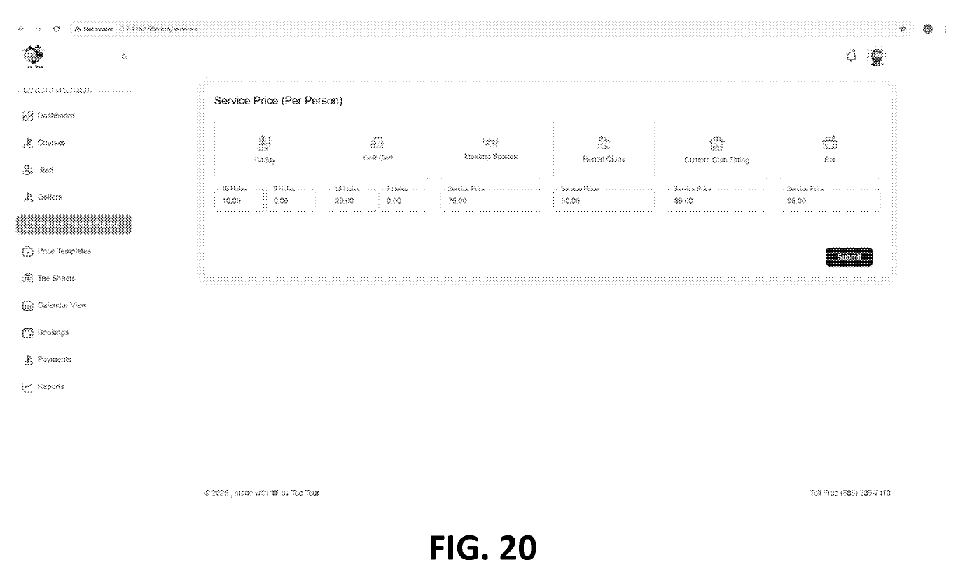

FIG. 20 shows an exemplary servicing pricing page of the present disclosure, whereby a golf course representative (or other user or administrator) can set prices for various golfing aspects, such as caddies, golf carts, meeting spaces, rental clubs, custom club fitting, bar, etc.

FIG. 21 shows an exemplary golf course management page, whereby a golf course representative (or other user or administrator) can manage onboarded golf course information or add an additional golf course to the system (onboarding).

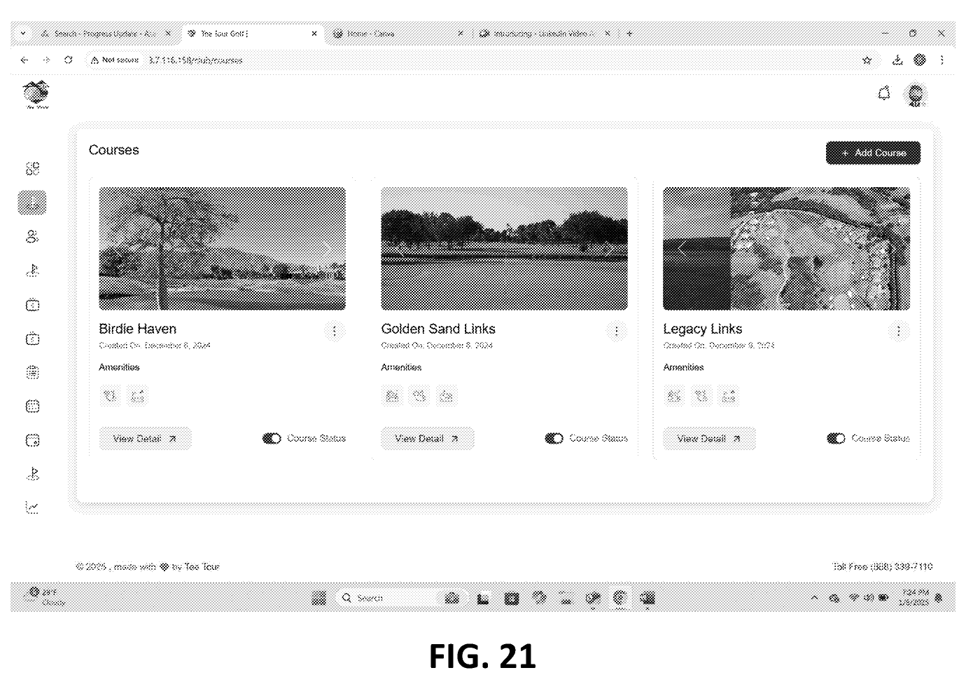

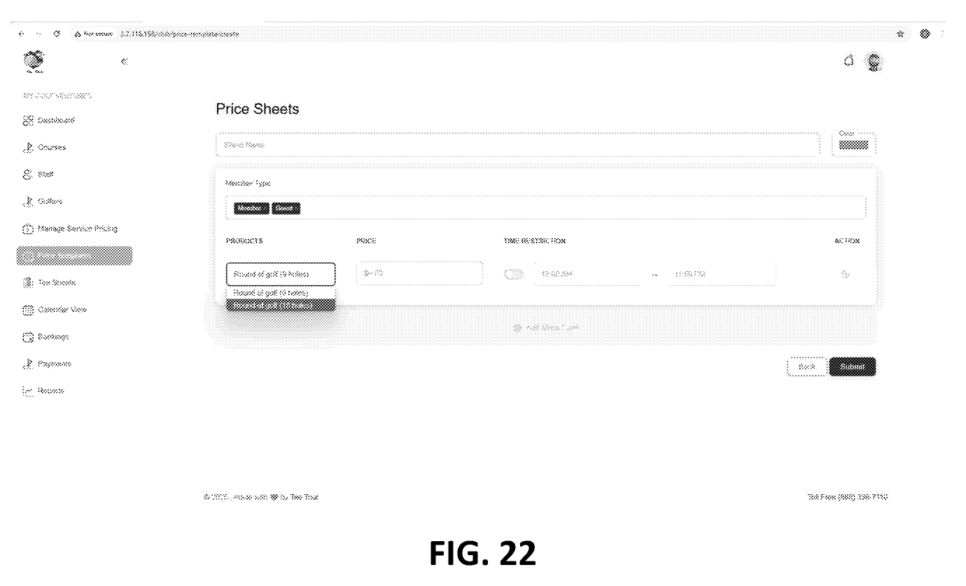

FIG. 22 shows an exemplary price template page of the present disclosure, whereby a golf course representative (or other user or administrator) can set the price to play nine or eighteen holes of golf at the selected course, with an available tee time range.

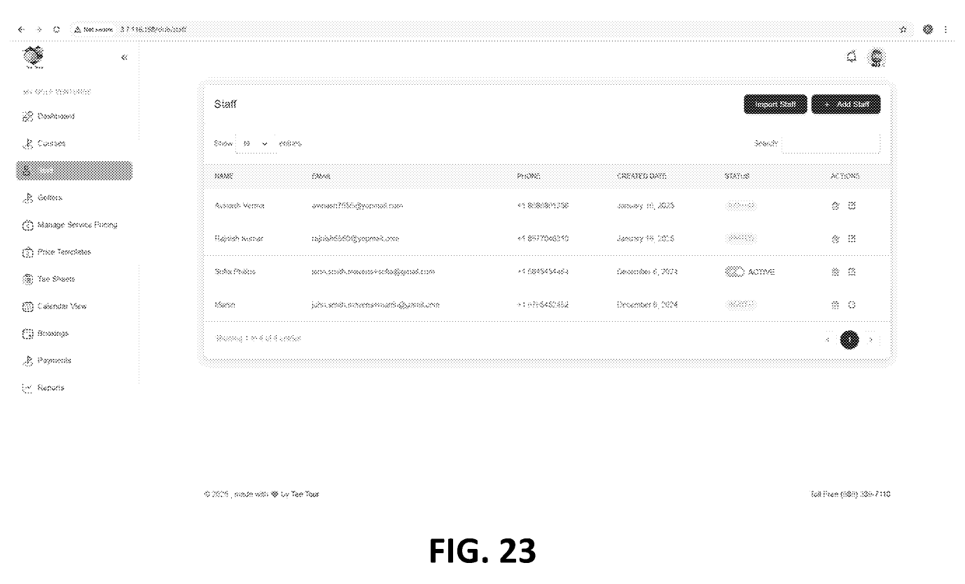

FIG. 23 shows an exemplary staff page, whereby a golf course representative (or other user or administrator) can manage staff information, including staff names, email addresses, phone numbers, status (invited by the golf course, for example, or actively a staff member in connection with the golf course), and the like.

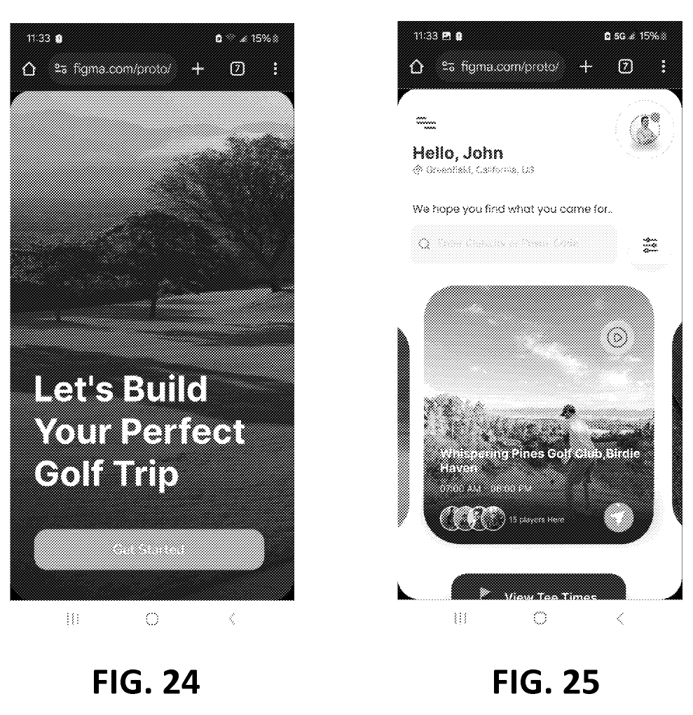

FIG. 24 shows an exemplary start screen for a smart device application.

FIG. 25 shows an exemplary golf course search screen for a smart device application whereby a user can search for any number of public golf courses.

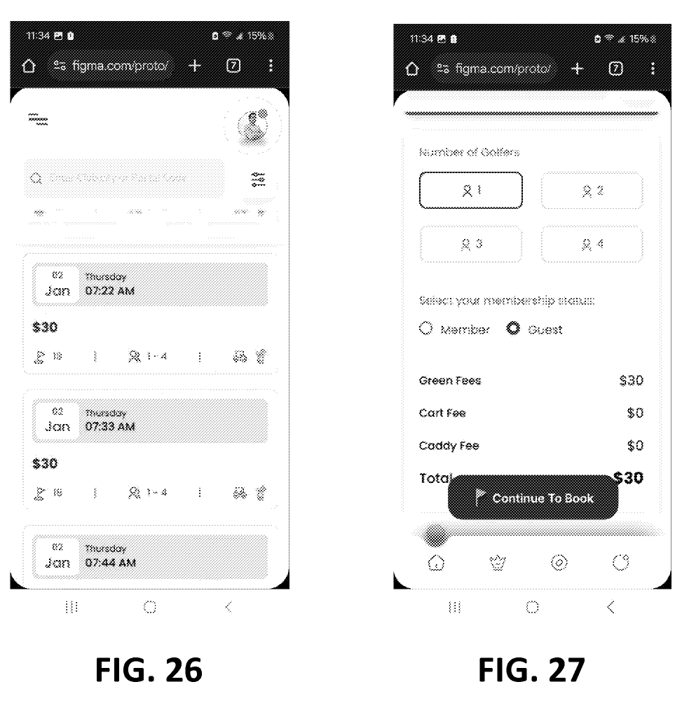

FIG. 26 shows an exemplary tee time selection screen for a smart device application, whereby a user can select from a number of available tee times.

FIG. 27 shows an exemplary booking screen for a smart device application, whereby a user can select the number of golfers playing in the group, select “member” or “guest” status, and see the costs in connection with said golf outing.

While various embodiments of systems and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A computer-implemented system for coordinating golf-related reservations, comprising:
at least one processor; and
a non-transitory computer-readable storage medium storing instructions that, when executed by the at least one processor, cause the system to:
(a) maintain a database of golf courses including tee time availability data and course attribute data;
(b) receive a search request from a user device;
(c) generate a list of available tee times based on the search request;
(d) enable selection and reservation of a tee time; and
(e) associate the reserved tee time with a user account.

2. The system of claim 1, wherein the instructions further cause the system to enable reservation of an accommodation at a hotel or resort in association with the reserved tee time.

3. The system of claim 1, wherein the course attribute data includes landscape attributes selected from mountains, lakes, rivers, oceanfront, forests, desert, and dunes.

4. The system of claim 1, wherein the instructions further cause the system to enable golf courses to register and manage tee time availability through an administrative interface.

5. The system of claim 1, wherein the instructions further cause the system to enable golf courses to list golf scramble events.

6. The system of claim 5, wherein users may register and submit payment for participation in a golf scramble.

7. The system of claim 1, wherein the instructions further cause the system to enable organization of a group golf outing including multiple tee times.

8. The system of claim 7, wherein the group golf outing includes coordinated lodging reservations.

9. The system of claim 1, wherein the instructions further cause the system to enable creation of a multi-course golf itinerary.

10. The system of claim 1, wherein the system processes payment for at least one of a tee time, accommodation, or golf event.

11. The system of claim 10, wherein the system retains a commission associated with the payment.

12. The system of claim 1, wherein the user device comprises a smart device executing a mobile application.

13. The system of claim 1, wherein tee time availability published to a consumer-facing marketplace is derived exclusively from a tee sheet managed within the system by the golf course.

14. The system of claim 1, wherein the golf course selectively controls which tee times are made publicly available for booking.

15. The system of claim 10, wherein a commission is retained for reservations generated through the marketplace portion of the platform.

16. The system of claim 1, wherein the system further provides point-of-sale functionality for food, beverage, or retail purchases associated with a golf course.

17. A computer-implemented method for coordinating golf reservations, comprising:
receiving tee time availability data from a plurality of golf courses;
receiving a search request from a user device;
generating a list of available tee times;
receiving a selection of a tee time; and
associating the selected tee time with a user account.

18. The method of claim 17, further comprising reserving an accommodation associated with the selected tee time.

19. The method of claim 17, further comprising filtering tee times based on landscape attributes.

20. The method of claim 17, further comprising at least one of:
registering a golf course and storing course profile data, listing golf scramble events and enabling user registration, organizing a group golf outing, processing payment for a reservation. and/or retaining a commission from the payment.
